(19) United States
(12) Patent Application Publication
(10) Pub. No.: US 2009/0303584 A1
(43) Pub. Date: Dec. 10, 2009

(54) METHOD FOR LASER SCANNING MICROSCOPY AND BEAM COMBINER

(76) Inventors: Joerg Pacholik, Kunitz (DE); Dieter Huhse, Berlin (DE); Thomas Paatzsch, Mainz (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 12/375,387

(22) PCT Filed: Jul. 24, 2007
(86) PCT No.: PCT/EP07/06549

§ 371 Date: Jul. 13, 2009

(30) Foreign Application Priority Data
Jul. 28, 2006 (DE) 10 2006 034 909.1

(51) Int. Cl. G02B 21/06; G02B 27/10

(52) U.S. Cl. 359/385; 359/618

(57) ABSTRACT

A method for laser scanning microscopy is characterized by the use of encapsulated fiber multiplexers from the telecommunications field for combining the beams of a plurality of lasers of different wavelengths and coupling them together into a laser scanning microscope and by corresponding beam combiners. Light-conducting guides to which different lasers can be coupled, preferably by light guides, are advantageously guided out of an encapsulated component.

The present application claims priority from PCT Patent Application No. PCT/EP2007/006549 filed on Jul. 24, 2007, which claims priority from German Patent Application No. DE 10 2006 034 909.1 filed on Jul. 28, 2006, the disclosure of which is incorporated herein by reference in its entirety.

### BACKGROUND OF THE INVENTION

1. Field of the Invention

The invention is directed to a method for laser scanning microscopy involving a beam combiner. The invention presents a compact, encapsulated, completely adjusted assembly containing the beam combiners. The laser sources are coupled in by fibers and are outputted in a combined manner via a fiber. The input fibers and output fibers are fixedly adjusted so that there is no need to adjust a fiber in relation to the beam combiner as in the prior art.

2. Description of the Related Art

Laser scanning systems use lasers of different power classes. Further, a laser scanning system is characterized by a large quantity of variable modules serving as detectors or for illumination. FIG. 1 is schematic diagram showing a beam path of a laser scanning microscope.

As is shown in FIG. 1, a laser scanning microscope (“LSM”) is substantially composed of four modules: light source, scan module, detection unit, and microscope. These modules are described in more detail in the following. In addition, reference is had to DE19702753A1.

Lasers of different wavelengths are used in an LSM for specific excitation of the different dyes in a specimen. The choice of excitation wavelength is governed by the absorption characteristics of the dyes to be examined. The excitation beam is generated in the light source module. Different lasers (argon, argon-krypton, TiSa) are used for this purpose. Further, the selection of wavelengths and the adjustment of the intensity of the required excitation wavelength are carried out in the light source module, e.g., by means of an acousto-optical crystal. Subsequently, the laser radiation reaches the scan module through a fiber or a suitable mirror arrangement.

The laser radiation generated in the light source is focused in the specimen in a diffraction-limited manner by means of the objective via the scanner, the scan optics and the tube lens. The focus scans the specimen point by point in the X-Y direction. The pixel dwell times during the scan over the sample are usually in the range of less than one microsecond to several hundred microseconds.

In case of a confocal detection (descanned detection) of the fluorescent light, the light which is emitted from the focus plane (specimen) and from the planes above and below the latter travels to a dichroic beamsplitter (MD) by way of the scanner. This dichroic beamsplitter separates the fluorescent light from the excitation light. The fluorescent light is subsequently focused on a diaphragm (confocal diaphragm/pinhole) which is located exactly in a plane conjugate to the focus plane. Fluorescent light located outside the focus is suppressed in this way.

The optical resolution of the microscope can be adjusted by varying the aperture size. Another dichroic blocking filter (EF) which again suppresses the excitation radiation is located behind the diaphragm. After passing the blocking filter, the fluorescent light is measured by a point detector (PMT).

When multiphoton absorption is used, the excitation of the dye fluorescence takes place within a small volume in which the excitation intensity is especially high. This area is only negligibly larger than the detected area when using a confocal arrangement. Therefore, a confocal diaphragm can be dispensed with and detection can be carried out directly after the objective (non-descanned detection).

In another arrangement for detection of a dye fluorescence excited by multiphoton absorption, descanned detection is carried out, but this time the pupil of the objective is imaged in the detection unit (non-confocal descanned detection).

In a three-dimensionally illuminated image, both detection arrangements in connection with the corresponding single-photon or multiphoton absorption will display only the plane (optical section) located in the focus plane of the objective. A three-dimensional image of the specimen can then be generated with the help of a computer by recording a plurality of optical sections in the X-Y plane at different depths Z of the specimen.

Accordingly, the LSM is suitable for examining thick specimens. The excitation wavelengths are determined by the dye employed with its specific absorption characteristics. Dichroic filters suited to the emission characteristics of the dye ensure that only the fluorescent light emitted by the respective dye will be measured by the point detector.

In current biomedical applications, a plurality of different cell regions are labeled simultaneously by different dyes (multiflourescence). In the prior art, the individual dyes can be detected separately based either on different absorption characteristics or on emission characteristics (spectra). For this purpose, an additional splitting of the fluorescent light of a plurality of dyes is carried out by the secondary beamsplitters (DBS) and the individual dye emissions are detected separately in separate point detectors (PMT x).

A very fast line scanner with image generation at 120 images per second is realized in the LSM LIVE by Carl Zeiss MicroImaging GmbH. (http://www.zeiss.de/c12567be00459794/Contents-Frame/fd9a0090eee01a641256a550036267b).

As a rule, the light source modules are connected to the scan module by light-conducting fibers. The coupling of a plurality of independent lasers into a fiber for transmitting to the scan head has been described, for example, in Pawley: “Handbook of Confocal Microscopy” Plenum Press, 1994, page 151 and in DE19633185A1.

In order to achieve optimal resolutions when measuring fluorescing specimens with a laser scanning microscope, these fluorescing samples must be illuminated by suitable laser sources with a high beam quality. In this connection, it is advisable to use a plurality of lasers with different wavelengths whose laser beams are superimposed spatially. In order at the same time to achieve a compact constructional shape with laser sources integrated in the scan head, compact beam combiners should be used in a suitable manner for superimposing the laser beams.

The use of adjusting mirrors, mirror steps and beam combiners as discrete, individually displaceable and adjustable components is known in the art. The assembly and adjustment of these components is complicated and sensitive. The environmental influences (temperature, dust, vibrations) to which these assemblies are exposed have a negative impact on performance, production costs, serviceability, reliability and customer-friendliness. It is also costly to implement the legally required laser safety measures. Further, the required servicing is time-consuming and expensive due to this complex construction.

### SUMMARY OF THE INVENTION

The invention makes possible a compact construction of a beam combiner for laser scanning microscopy, for example, by means of a Cubo fiber multiplexer or a comparable component. No assembly or adjustment of mirrors and splitters is required. The encapsulated assembly provides for a robust construction which is resistant to environmental influences such as temperature, dust and vibrations and therefore operates with markedly increased in reliability. The considerable savings in weight is also advantageous. The self-contained beam combiner is laser-safe depending on the technology.

### BRIEF DESCRIPTION OF THE DRAWINGS

FIG. 1 is schematic diagram showing a beam path of a laser scanning microscope;

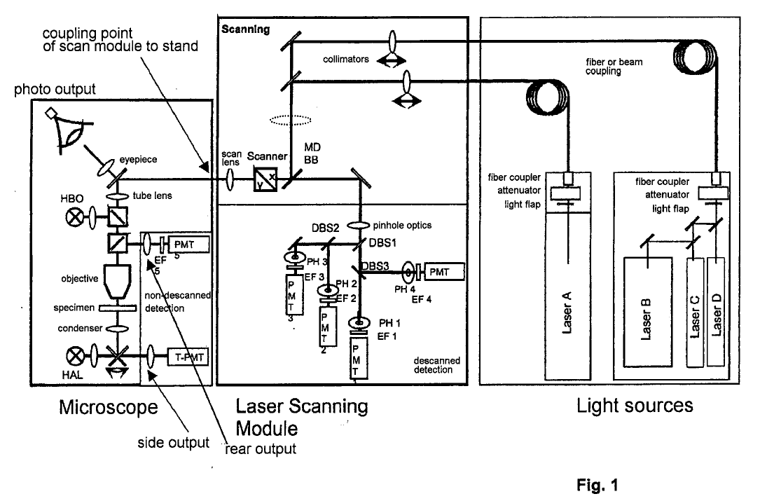

FIG. 2 is schematic diagram showing an embodiment of the current invention; and

FIG. 3 shows an embodiment of the current invention.

### DETAILED DESCRIPTION OF EMBODIMENTS

It is to be understood that the figures and descriptions of the present invention have been simplified to illustrate elements that are relevant for a clear understanding of the present invention, while eliminating, for purposes of clarity, many other elements which are conventional in this art. Those of ordinary skill in the art will recognize that other elements are desirable for implementing the present invention. However, because such elements are well known in the art, and because they do not facilitate a better understanding of the present invention, a discussion of such elements is not provided herein.

The present invention will now be described in detail on the basis of exemplary embodiments.

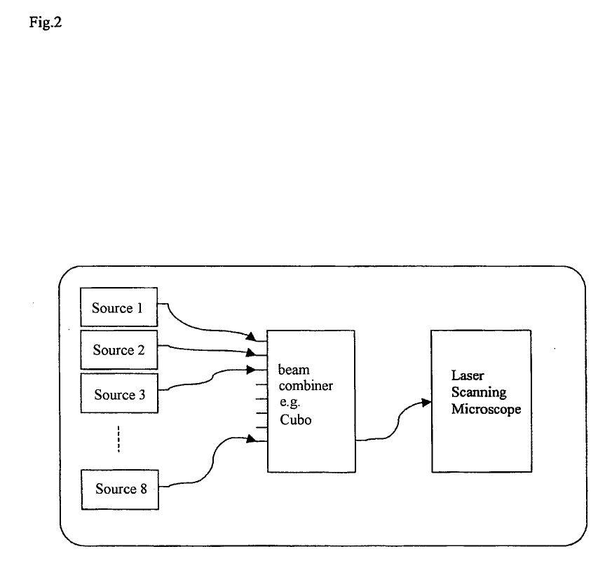

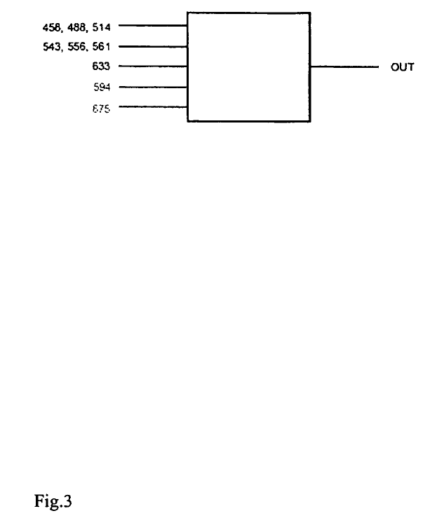

The invention is shown schematically in FIG. 2. An encapsulated component known from telecommunications, preferably fabricated by TTF thin-film techniques, is suitable for combining the light of, e.g., eight light sources which is guided through fibers and for guiding the light to the microscope (scan head) of an LSM in an advantageous manner by a polarity-preserving glass fiber. FIG. 3 shows a possible embodiment form.

The solution presents a compact, encapsulated, completely adjusted assembly containing the beam combiners. The laser sources are coupled in by fibers and are outputted in a combined manner via a fiber. The input fibers and output fibers are fixedly adjusted so that there is no need to adjust a fiber in relation to the beam combiner as in the prior art.

The invention makes possible a compact construction of a beam combiner, for example, by means of a Cubo fiber multiplexer or a comparable component. No assembly or adjustment of mirrors and splitters is required. The encapsulated assembly provides for a robust construction which is resistant to environmental influences such as temperature, dust and vibrations and therefore operates with markedly increased in reliability. The considerable savings in weight is also advantageous. The self-contained beam combiner is laser-safe depending on the technology.

The fact that the component manufactured by the Cubo company was originally applied in the telecommunications field makes it possible to reduce production costs.

When the fiber coupling points to the sources (lasers) are implemented by means of high-efficiency fiber connectors, it is easy for the customer to exchange a modular source independently without expenditure on adjustment corresponding to the desired application and without the assistance of servicing personnel.

The invention points to the surprising use of one or more compact encapsulated beam combiners from glass fiber technology (e.g., by the Cubo company http://cubeoptics.com/impressum.php) in laser scanning microscopy.

Technology of this kind is also known from http://www.auxora.com/application.asp. However, their special advantage described herein for laser scanning microscopes was not recognized.

Instead of adjusting individual optical elements with respect to one another, a suitable holder with precisely guided stops is used so that all adjustments can be carried out purely passively (e.g., multiplexer by the Cubo company).

This prior solution from the telecommunications industry is used explicitly for laser scanning microscopy.

While this invention has been described in conjunction with the specific embodiments outlined above, it is evident that many alternatives, modifications, and variations will be apparent to those skilled in the art. Accordingly, the preferred embodiments of the invention as set forth above are intended to be illustrative, not limiting. Various changes may be made without departing from the spirit and scope of the inventions as defined in the following claims.

1. A method for laser scanning microscopy;
wherein thin-film technology from the telecommunications field is used for combining the beams of a plurality of lasers of different wavelengths and coupling them together into a laser scanning microscope.

2. An encapsulated beam combiner for a laser scanning microscope, comprising thin-film filters (TTF) for combining a plurality of wavelengths.

3. The method for laser scanning microscopy;
wherein encapsulated fiber multiplexers from telecommunications are used for combining the beams of a plurality of lasers of different wavelengths and coupling them together into a laser scanning microscope.

4. A beam combiner according to claim 1;
wherein light-conducting guides to which different lasers can be coupled, preferably by light guides, are guided out of an encapsulated component.

5. A beam combiner according to claim 1;
wherein at least the wavelengths 405 nm, 488 nm, 555 nm and 635 nm are combined and are guided to a polarity-preserving glass fiber.
